(19) United States
(12) Patent Application Publication
(10) Pub. No.: US 2009/0297289 A1
(43) Pub. Date: Dec. 3, 2009

(54) FASTENING COMPONENT, FASTENING UNIT, AND DEVICE HAVING THE FASTENING UNIT

(75) Inventors: Sheen-Yan Torn, Taipei County (TW); Guan-De Liou, Taipei City (TW); Stephen Tsai, Taipei County (TW)

Correspondence Address: MCNEES WALLACE & NURICK LLC, 100 PINE STREET, P.O. BOX 1166, HARRISBURG, PA, 17108-1166, US

(73) Assignee: HANNSPREE, INC., Taipei City (TW)

(21) Appl. No.: 12/339,895

(22) Filed: Dec. 19, 2008

(30) Foreign Application Priority Data
May 30, 2008 (TW) 097120228

(51) Int. Cl. F16B 21/00

(52) U.S. Cl. 411/82; 411/511; 411/512

(57) ABSTRACT

A fastening unit includes a fastening component and a hole-defining unit. The fastening component is adapted to be fixed to a first body, and includes a cylindrical post body and at least one surrounding member. The post body extends along a post axis. The surrounding member surrounds and is fixed to an outer post surface of the post body, and a portion of lines tangent to points on an outermost perimeter of the surrounding member are at non-90° angles with respect to the post axis. The hole-defining unit is adapted to be provided in a surface of a second body, and defines a fastener hole that fittingly receives the fastening component for interconnecting the first and second bodies.

### CROSS-REFERENCE TO RELATED APPLICATION

This application claims priority of Taiwanese application no. 097120228, filed on May 30, 2008.

### BACKGROUND OF THE INVENTION

1. Field of the Invention

This invention relates to a fastening unit, more particularly to a fastening unit that allows for quick assembly of two bodies.

2. Description of the Related Art

With the advancement in electronic technology, electronic devices such as Liquid Crystal Display (LCD) devices and televisions have become an indispensable part of modern life. Efficient assembly of the electronic device is therefore important.

FIG. 1 illustrates a conventional electronic device 9 (in this case, a display device) provided with a custom-designed form. In order to enable assembly of an external connecting component 92 to a device body 91, the external connecting component 92 comprises a threaded post 93 protruding from an outer surface of the external connecting component 92. Typically, the threaded post 93 is pre-fabricated, and has one end embedded in the external connecting component 92 during fabrication of the external connecting component 92. The device body 91 is correspondingly provided with a threaded hole 94 at a desired position on an outer surface of the device body 91. When the threaded post 93 is screwed into and engages threadedly the threaded hole 94, the external connecting component 92 is assembled securely to the device body 91.

However, assembly of the external connecting component 92 to the device body 91 via threaded engagement between the threaded post 93 and the threaded hole 94 is time consuming and thus increases labor cost.

### SUMMARY OF THE INVENTION

Therefore, an object of the present invention is to provide a fastening unit that allows for quick assembly of two bodies.

According to the present invention, a device comprises a first body, a second body, and a fastening unit. The fastening unit includes a fastening component and a hole-defining unit. The fastening component is fixed to the first body, and includes a cylindrical post body and at least one surrounding member. The cylindrical post body extends along a post axis. The surrounding member surrounds and is fixed to an outer post surface of the post body, and a portion of lines tangent to points on an outermost perimeter of the surrounding member are at non-90° angles with respect to the post axis. The hole-defining unit is provided in a surface of the second body, and defines a fastener hole that fittingly receives the fastening component for interconnecting the first and second bodies.

With regard to the manner in which the surrounding member is fixed to the outer post surface, the outer post surface of the post body can be formed with at least one groove equal in number to and having a shape complementing the surrounding member for receiving a section of the surrounding member so as to retain the surrounding member therein. Alternatively, the surrounding member can be adhered to the outer post surface of the post body. Of course, an adhesive can be used to adhere the surrounding member in the groove.

The surrounding member can be made of a silicone resin material, a rubber material, or another type of resilient material, and can have a closed ring shape, such as an O-ring, an open ring shape, such as a C-ring, or a helical shape.

In an embodiment of the invention, the fastening component is pre-fabricated, and has one end embedded in the first body during fabrication of the first body through one of an injection molding and a foam molding process. Alternatively, the post body of the fastening component and the first body can be integrally formed.

In an embodiment of the invention, the first body is one of a display device and an external connecting component, and the second body is the other of the display device and the external connecting component.

When the fastening component is pushed into the fastener hole to interconnect the first and second bodies, friction provided by the surrounding member of the fastening component resists rotation of the fastening component in the fastener hole and resists movement of the fastening component in the fastener hole along an axial direction of the fastener hole. The first and second bodies are thus quickly and securely assembled.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional electronic device;

FIG. 2 is a perspective view of a first preferred embodiment of a device according to the present invention, showing first and second bodies of the device prior to assembly;

FIG. 3 is a partly exploded perspective view of a fastening component of the preferred embodiment; and

FIG. 4 is a schematic view to illustrate a line tangent to a point on an outermost perimeter of a surrounding member and at a non-90° angle with respect to a post axis of the fastening component of the preferred embodiment.

### DETAILED DESCRIPTION OF THE PREFERRED EMBODIMENT

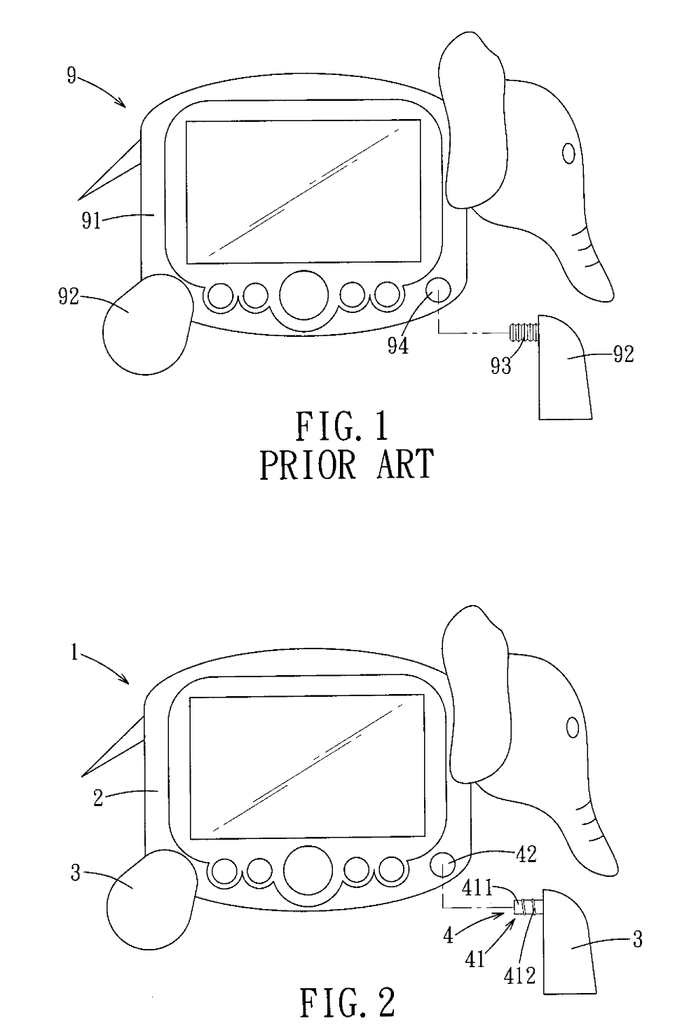

FIG. 2 illustrates a preferred embodiment of a device 1 according to the present invention. The device 1 comprises a first body 3, a second body 2, and a fastening unit 4. In this embodiment, the device 1 is an electronic device having a custom-designed form. In particular, the first body 3 is an external connecting component, and the second body 2 is a display device. However, the device 1 of the present invention is not limited to the electronic device, and can be any device that comprises the first and second bodies 3,2 and the fastening unit 4, wherein the first and second bodies 3,2 are separate bodies that can be interconnected by the fastening unit 4.

The fastening unit 4 includes a fastening component 41 and a hole-defining unit. The hole-defining unit includes a hole-defining wall that defines a fastener hole 42 that fittingly receives the fastening component 41 for interconnecting the first and second bodies 3,2. In this embodiment, the fastening component 41 is fixed to the first body 3, and the hole-defining unit is disposed in a surface of the second body 2. In this embodiment, the fastening component 41 has one end embedded in the first body 3. That is, the fastening component 41 can be pre-fabricated, and one end of the fastening component 41 is embedded in the first body 3 during fabrication of the first body 3 through an injection molding or foam molding process.

However, the manner in which the fastening component 41 is fixed to the first body 3 is not limited to what is described above. In practice, the fastening component 41 and the first body 3 can be integrally formed. Similarly, the arrangement of the fastening component 41 and the hole-defining unit is not limited to what is described above. For example, in a case where the second body 2 is the external connecting component and the first body 3 is the display device, the hole-defining unit can still be provided in the second body 2, and the fastening component 41 can be fixed to the first body 3.

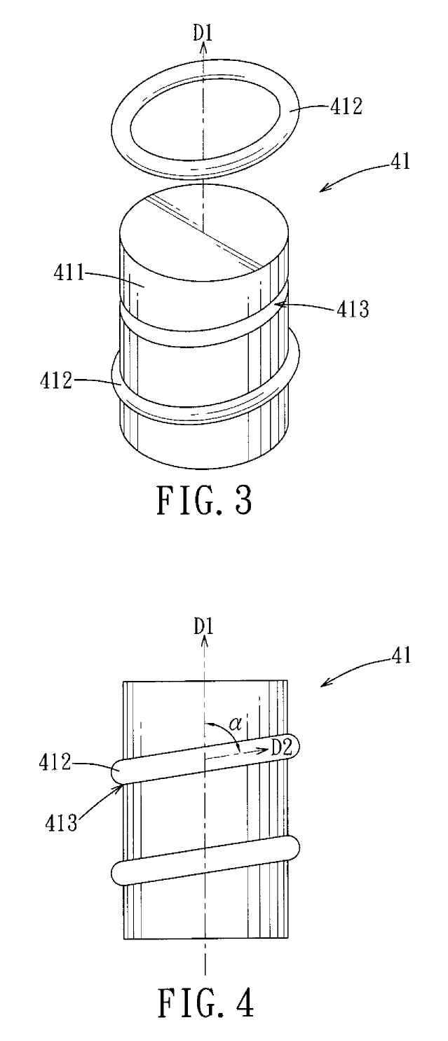

Referring to FIGS. 3 and 4, the fastening component 41 is provided with a cylindrical post body 411 extending along a post axis (D1), and a plurality of surrounding members 412 that surround and that are fixed to an outer post surface of the post body 411. In this embodiment, there are two surrounding members 412. The surrounding members 412 are made of a silicone resin material, a rubber material, or another type of resilient material. Each of the surrounding members 412 has a shape of a closed ring, such as an O-ring, and is fixed to the outer post surface of the post body 411 such that a line (D2) tangent to a point on an outermost perimeter of the surrounding member 412 is at a non-90° angle (α) with respect to the post axis (D1). That is, a projection of the line (D2) forms a non-90° angle (α) with the post axis (D1). Of course, only a portion of lines tangent to points on the outermost perimeter of the surrounding member 412 must form non-90° angles (α) with respect to the post axis (D1) to be within the scope of this invention.

When the fastening component 41 is pushed into the fastener hole 42 to interconnect the first and second bodies 3,2, the surrounding members 412 are compressed and produce friction between the post body 411 and the hole-defining wall of the hole-defining unit, thereby preventing easy removal of the fastening component 41 from the fastener hole 42 along an axial direction. Moreover, since each of the surrounding members 412 is configured such that a line (D2) tangent to a point on the outermost perimeter of the surrounding member 412 is not perpendicular to the post axis (D1), the surrounding members 412 have a greater area of contact with the hole-defining wall along the axial direction, which enables production of increased friction between the surrounding members 412 and the hole-defining wall that resists rotation of the fastening component 41 in the fastener hole 42. The fastening component 41 is thereby securely fastened in the fastener hole 42.

As previously mentioned, the surrounding member 412 is fixed to the outer post surface of the post body 411. Preferably, the outer post surface of the post body 411 is formed with at least one groove equal in number to and having a shape complementing the surrounding member 412 for receiving a section of the surrounding member 412. Referring to FIG. 3, in this embodiment, the outer post surface of the post body 411 is formed with a pair of spaced apart annular grooves 413 for receiving sections of the surrounding members 412. The resilient material of the surrounding members 412 enables retention of the surrounding members 412 in the annular grooves 413, thereby fixing the surrounding members 412 on the outer post surface of the post body 411.

However, the manner in which the surrounding member 412 is fixed to the outer post surface of the post body 411 is not limited to what is described above. Alternatively, the outer post surface of the post body 411 can be designed without the annular grooves 413, and the surrounding members 412 can, by virtue of the resilient material, surround tightly the outer post surface of the post body 411. In yet another alternative, an adhesive (not shown) can be used to adhere the surrounding members 412 to the outer post surface of the post body 411. Of course, the adhesive can also be used to adhere the surrounding members 412 in the annular grooves 413, thereby achieving the effect of attaching the surrounding members 412 to the outer post surface of the post body 411.

Although the number of surrounding members 412 in this embodiment is two, the number of surrounding members 412 is not limited to two, and can be just one, or three or more. Moreover, the surrounding member 412 can have an open ring shape, such as a C-ring, or a helical shape, as long as a portion of lines tangent to points on an outermost perimeter of the surrounding member 412 are at non-90° angles with respect to the post axis (D1). As previously mentioned, the outer post surface of the post body 411 can be formed with a helical groove 413 complementing the helical surrounding member 412.

In sum, when the fastening component 41 is pushed into the fastener hole 42, the surrounding members 412 are compressed and provide friction between the outer post surface of the post body 411 and the hole-defining wall so that the fastening component 41 is not easily removed from the fastener hole 42 along the axial direction. Moreover, since each of the surrounding members 412 is configured such that a line (D2) tangent to a point on the outermost perimeter of the surrounding member 412 is not perpendicular to the post axis (D1), the surrounding members 412 have a greater area of contact with the hole-defining wall along the axial direction, which enables more friction between the surrounding members 412 and the hole-defining wall that resists rotation of the fastening component 41 in the fastener hole 42. Therefore, when it is desired to interconnect the first and second bodies 3, 2, it is only necessary to push the fastening component 41 into the fastener hole 42. The device 1 of the present invention is thus capable of quick assembly.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A fastening component comprising:
a cylindrical post body extending along a post axis; and
at least one surrounding member that surrounds and that is fixed to an outer post surface of said post body, a portion of lines tangent to points on an outermost perimeter of said surrounding member being at non-90° angles with respect to the post axis.

2. The fastening component as claimed in claim 1, wherein said surrounding member is made of one of a silicone resin material and a rubber material.

3. The fastening component as claimed in claim 1, wherein said surrounding member has one of a closed ring shape, an open ring shape, and a helical shape.

4. The fastening component as claimed in claim 2, wherein said surrounding member has one of a closed ring shape, an open ring shape, and a helical shape.

5. The fastening component as claimed in claim 1, wherein said outer post surface of said post body is formed with at least one groove equal in number to and having a shape complementing said surrounding member for receiving a section of said surrounding member.

6. The fastening component as claimed in claim 1, wherein said surrounding member is adhered to said outer post surface of said post body.

7. A fastening unit adapted for interconnecting a first body and a second body, said fastening unit comprising:
a fastening component adapted to be fixed to the first body, and including
a cylindrical post body extending along a post axis, and
at least one surrounding member that surrounds and that is fixed to an outer post surface of said post body, a portion of lines tangent to points on an outermost perimeter of said surrounding member being at non-90° angles with respect to the post axis; and
a hole-defining unit adapted to be provided in a surface of the second body and defining a fastener hole that fittingly receives said fastening component for interconnecting the first and second bodies.

8. The fastening unit as claimed in claim 7, wherein said fastening component is pre-fabricated, and has one end embedded in the first body during fabrication of the first body through one of an injection molding and a foam molding process.

9. The fastening unit as claimed in claim 7, wherein said post body of said fastening component and the first body are integrally formed.

10. The fastening unit as claimed in claim 7, wherein said surrounding member is made of one of a silicone resin material and a rubber material.

11. The fastening unit as claimed in claim 7, wherein said surrounding member has one of a closed ring shape, an open ring shape, and a helical shape.

12. The fastening unit as claimed in claim 9, wherein said surrounding member has one of a closed ring shape, an open ring shape, and a helical shape.

13. The fastening unit as claimed in claim 10, wherein said surrounding member has one of a closed ring shape, an open ring shape, and a helical shape.

14. The fastening unit as claimed in claim 7,wherein said outer post surface of said post body is formed with at least one groove equal in number to and having a shape complementing said surrounding member for receiving a section of said surrounding member.

15. The fastening unit as claimed in claim 7, wherein said surrounding member is adhered to said outer post surface of said post body.

16. A device, comprising:
a first body;
a second body; and
a fastening unit including
a fastening component fixed to said first body, and including:
a cylindrical post body extending along a post axis, and
at least one surrounding member that surrounds and that is fixed to an outer post surface of said post body, a portion of lines tangent to points on an outermost perimeter of said surrounding member being at non-90° angles with respect to the post axis; and
a hole-defining unit provided in a surface of said second body and defining a fastener hole that fittingly receives said fastening component for interconnecting said first and second bodies.

17. The device as claimed in claim 16, wherein said fastening component is pre-fabricated, and has one end embedded in said first body during fabrication of said first body through one of an injection molding and a foam molding process.

18. The device as claimed in claim 16, wherein said post body of said fastening component and said first body are integrally formed.

19. The device as claimed in claim 16, wherein said surrounding member is made of one of a silicone resin material and a rubber material.

20. The device as claimed in claim 16, wherein said surrounding member has one of a closed ring shape, an open ring shape, and a helical shape.

21. The device as claimed in claim 18, wherein said surrounding member has one of a closed ring shape, an open ring shape, and a helical shape.

22. The device as claimed in claim 19, wherein said surrounding member has one of a closed ring shape, an open ring shape, and a helical shape.

23. The device as claimed in claim 16, wherein said outer post surface of said post body is formed with at least one groove equal in number to and having a shape complementing said surrounding member for receiving a section of said surrounding member.

24. The device as claimed in claim 16, wherein said surrounding member is adhered to said outer post surface of said post body.

25. The device as claimed in claim 16, wherein said first body is one of a display device and an external connecting component, and said second body is the other of said display device and said external connecting component.
